(19) United States
(12) Patent Application Publication
(10) Pub. No.: US 2018/0319054 A1
(43) Pub. Date: Nov. 8, 2018

(54) MOLDING DEVICE HAVING COOLING FUNCTION

(71) Applicant: POU CHEN CORPORATION, Chang Hwa Hsien (TW)

(72) Inventors: Hsiang-Yu HUANG, Taichung City (TW); Shih-Chia LIN, Yuanlin City (TW); Hung-Wu HSIEH, Xizhou Township (TW); Ju-Cheng CHEN, Tainan City (TW); Tsung-Wei KUO, Changhua City (TW)

(21) Appl. No.: 15/968,535

(22) Filed: May 1, 2018

(30) Foreign Application Priority Data
May 3, 2017 (TW) 106114627

(51) Int. Cl. B29C 44/58; B29C 44/34; B33Y 80/00; B29D 35/12

(52) U.S. Cl. CPC B29C 44/58; B29D 35/128; B33Y 80/00; B29C 44/3415

(57) ABSTRACT

A mold device includes a lower mold seat, a lower die core assembly mounted to the lower mold seat and including a lower die core unit defining a mold cavity, an upper mold seat, and an upper die core assembly mounted to the upper mold seat and including an upper die core unit covering the mold cavity. The lower die core unit includes an internal loop for a cooled gas to flow therethrough, and is made of a first porous material so as to allow the cooled gas to flow out of the lower die core unit. The upper die core unit includes an upper die core passage for the cooled gas to flow therethrough, and is made of a second porous material so as to allow the cooled gas to flow out of the upper die core unit.

### CROSS-REFERENCE TO RELATED APPLICATION

This application claims priority of Taiwanese Invention Patent Application No. 106114627, filed on May 3, 2017.

### FIELD

The disclosure relates to a molding device, and more particularly to a molding device having cooling function for cooling down a molded foaming material.

### BACKGROUND

Ethylene-vinyl acetate (EVA) foam material or thermoplastic polyurethane (TPU) foam material are widely used in making insole or outsole of shoes because of their superior cushion, shock-absorbing, heat insulation, moistureproof, chemical resistant properties. EVA and TPU are also nontoxic and non-water absorbing, which is quite environment friendly.

Referring to FIG. 1, a conventional molding device 1 disclosed by Taiwanese Invention Patent No. 576329 includes a heating mold assembly 11, a cooling mold assembly 12 and a conveying unit 13. The heating mold assembly 11 includes a lower mold 111, an upper mold 113 that is removably connected to the lower mold 111 to cooperate with the lower mold 111 to define a first mold cavity 112 therebetween. The heating mold assembly 11 further includes a plurality of heating members 114, such as resistive heater, that are disposed in the lower and upper molds 111, 113. The cooling mold assembly 12 includes a lower mold 121, an upper mold 123 that is removably connected to the lower mold 121 to define a second mold cavity 122 therebetween. The cooling mold assembly 12 further includes a plurality of cooling passages 124 that are formed in the lower mold 121 and the upper mold 123.

When the heating members 114 are heated up, the lower and upper molds 111, 113 will also be heated up via thermal conduction to heat up a foaming material received in the first mold cavity 112. Afterwards, the conveying unit 13 is operated to move the molded foaming material from the first mold cavity 112 to the second mold cavity 122, followed by covering the second mold cavity 122 with the upper mold 123. A cooling liquid is then fed into the cooling passages 124 to cool down the molded foaming material in the second mold cavity 122.

However, the molded foaming material is softened after being heated. Therefore, a user needs to wait for the molded foaming material to slightly cool down in the first mold cavity 112 before the conveying unit 13 moves the molded foaming material therefrom, which is time-consuming. Moreover, when cooling, the cooling effect is better in the regions of the molded foaming material in which the cooling passages 124 directly pass through. Therefore, it is desirable to increase cooling uniformity of the cooling mold assembly 12.

### SUMMARY

Therefore, an object of the disclosure is to provide a molding device that can alleviate at least one of the drawbacks of the prior art.

According to the aspect of the present disclosure, a molding device is adapted to cool down a molded foaming material.

The molding device includes a lower mold seat, a lower die core assembly, an upper mold seat and an upper die core assembly.

The lower die core assembly is mounted to the lower mold seat, and includes a lower die core unit that defines a mold cavity. The lower die core unit includes an internal loop adapted for a cooled gas to flow therethrough, and is made of a first porous material so as to allow the cooled gas to flow out of the lower die core unit. The upper die core assembly is mounted to the upper mold seat, and includes an upper die core unit that covers the mold cavity. The upper die core unit includes an upper die core passage adapted for the cooled gas to flow therethrough, and is made of a second porous material so as to allow the cooled gas to flow out of the upper die core unit.

### BRIEF DESCRIPTION OF THE DRAWINGS

Other features and advantages of the disclosure will become apparent in the following detailed description of the embodiment and variation with reference to the accompanying drawings, of which:

FIG. 1 is a schematic view of a molding device according to Taiwanese Invention Patent No. 576329;

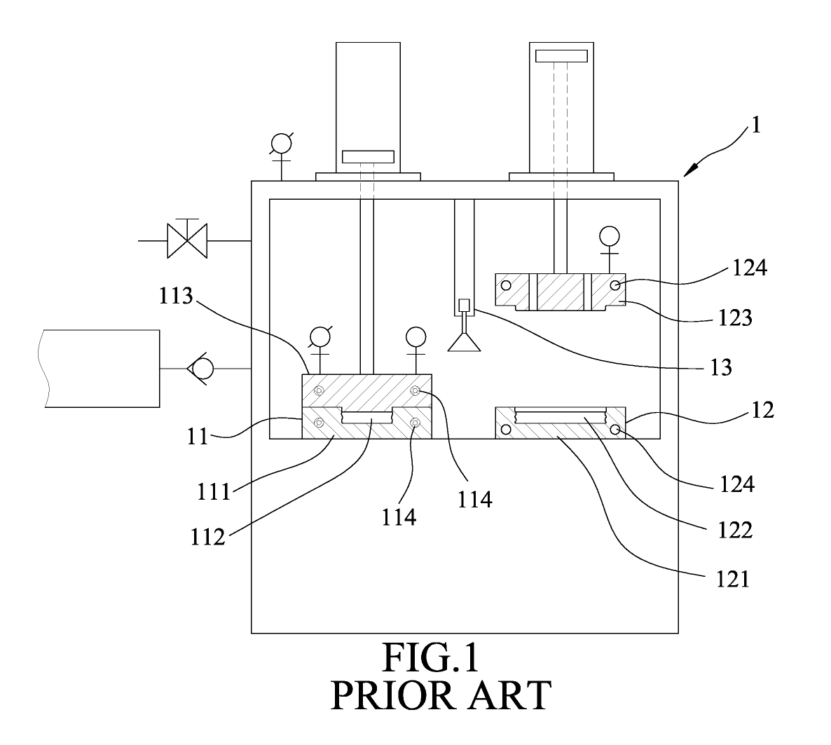

FIG. 2 is a sectional view of an embodiment of a molding device according to the present disclosure;

FIG. 3 is a top view of a lower mold seat and a lower die core assembly of the embodiment, showing the lower die core assembly in a closed state;

FIG. 4 is a sectional view of the embodiment taken along line IV-IV of FIG. 2;

FIG. 5 is a sectional view of the embodiment taken along line V-V of FIG. 2;

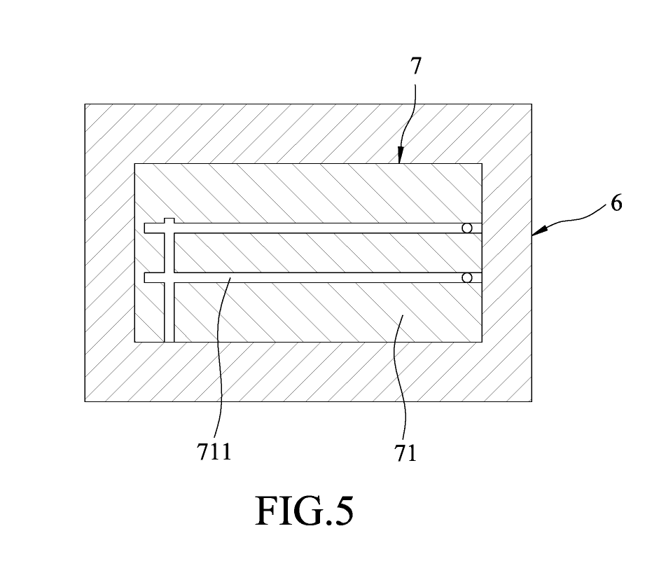

FIG. 6 is a partly exploded sectional view of the embodiment, showing the lower die core assembly in an open state and an upper mold seat of the embodiment spaced apart from the lower mold seat;

FIG. 7 is a top view of the lower mold seat and the lower die core assembly of the embodiment, showing the lower die core assembly in the open state.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

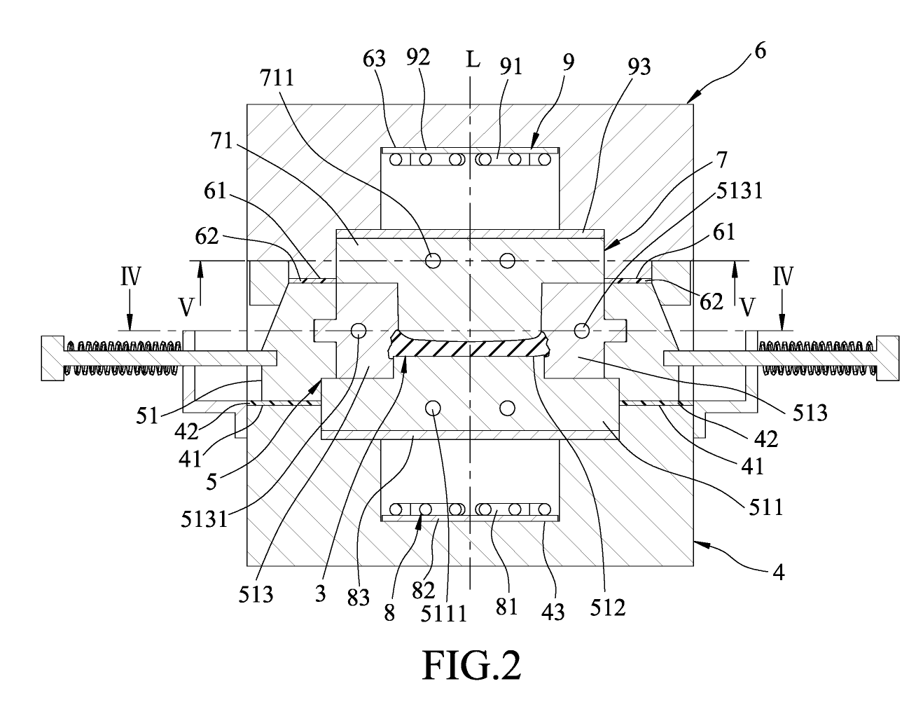

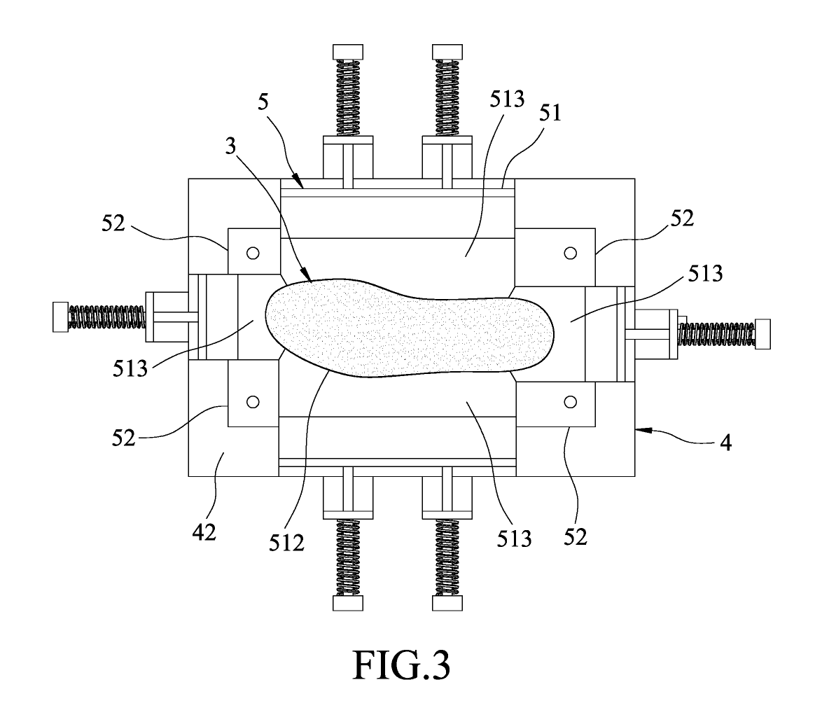

Referring to FIGS. 2 and 3, an embodiment of a molding device according to the present disclosure is adapted to heat-mold a foaming material 3 and to cool down the molded foaming material 3 to form a product (not shown), such as a shoe sole. The molding device includes a lower mold seat 4, a lower die core assembly 5, an upper mold seat 6, an upper die core assembly 7, a lower heating unit 8 and an upper heating unit 9.

In this embodiment, the lower mold seat 4 is made of steel, and includes a lower mounting portion 43 that is downwardly concaved along a central axis (L), an upward facing surface 41 that faces the upper mold seat 6 and a lower insulating layer 42 that is formed on the upward facing surface 41.

The lower die core assembly 5 is mounted in the lower mounting portion 43 of the lower mold seat 4, and includes a lower die core unit 51 that defines a mold cavity 512, at least two positioning blocks 52 and a plurality of sealing members 53. In this embodiment, the lower die core assembly 5 includes four of the positioning blocks 52. The lower die core unit 51 includes an internal loop that is adapted for a cooled gas to flow therethrough, and is made of a first porous material, such as steel or copper, so as to allow the cooled gas to flow out of the lower die core unit 51. Detailed description of the internal loop of the lower die core unit 51 will be provided hereinafter. In this embodiment, the lower die core unit 51 is made by one of powder metallurgy and 3D printing. The lower die core unit 51 further includes a mold plate 511 that is mounted in the lower mounting portion 43 of the lower mold seat 4, and at least two lower die cores 513 that surround the central axis (L), that are movably disposed on the mold plate 511, and that cooperate with the mold plate 511 to define the mold cavity 512. In this embodiment, the lower die core unit 51 includes four of the lower die cores 513. The mold plate 511 includes a mold plate passage 5111 that is adapted for the cooled gas to flow therethrough. The positioning blocks 52 are fixedly disposed on the mold plate 511 of the lower die core unit 51. Each of the positioning blocks 52 includes a positioning block passage 521. Each of the lower die cores 513 includes a lower die core passage 5131, and is disposed between adjacent two of the positioning blocks 52. Each of the sealing members 53 includes a connecting passage 531 and is sealingly disposed between a corresponding one of the lower die cores 513 and a corresponding one of the positioning blocks 52.

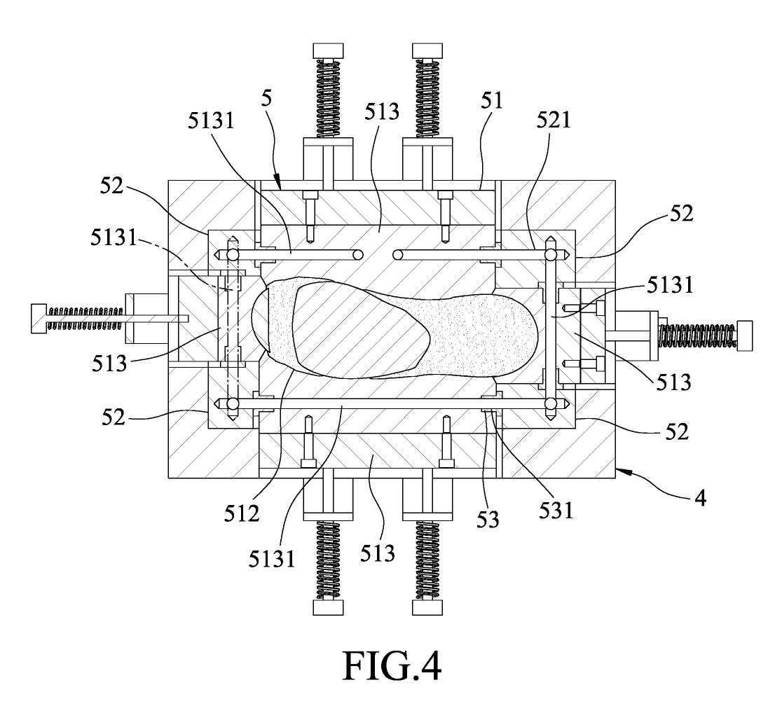

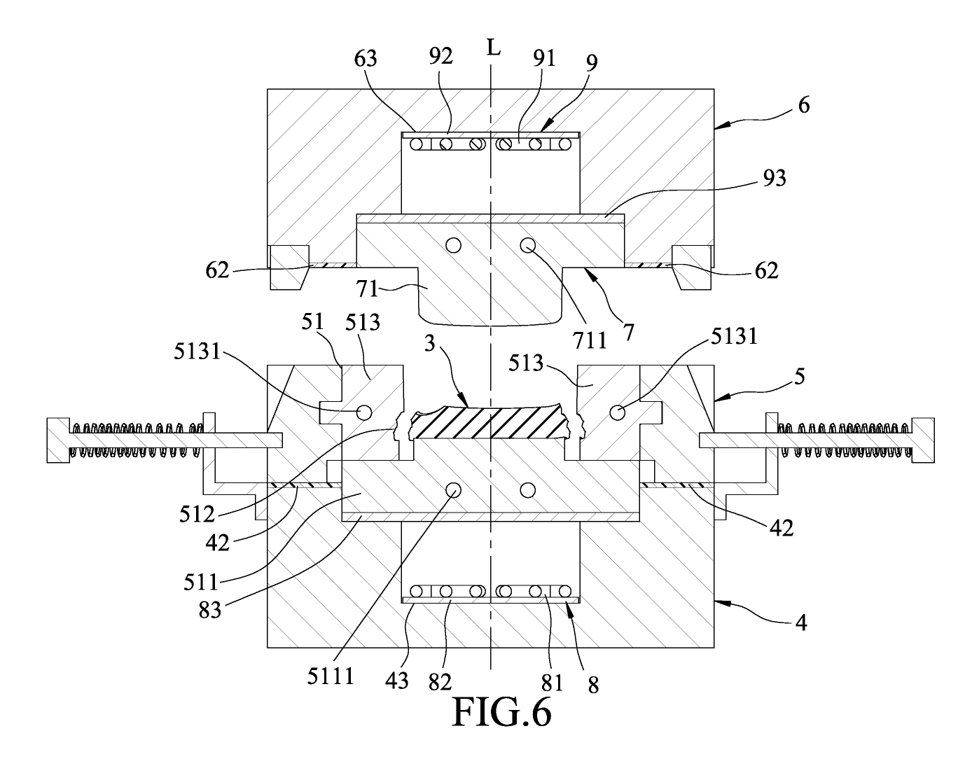

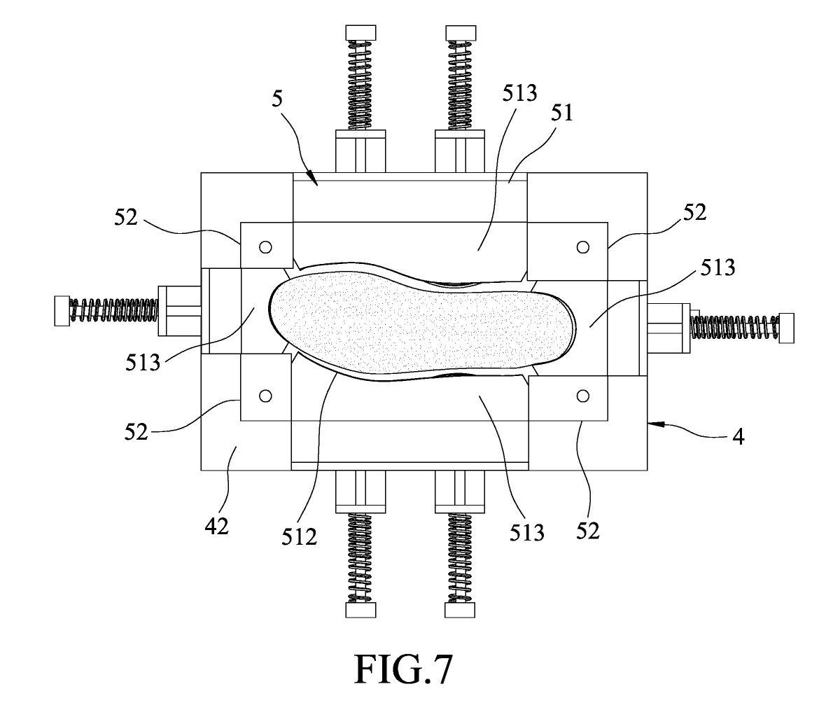

The lower die core assembly 5 is convertible between a closed state (see FIGS. 2, 3 and 4), where the lower die core passage 5131 of each of the lower die cores 513 is fluidly communicated with the positioning block passages 521 of the adjacent two of the positioning blocks 52, and an open state (see FIGS. 6 and 7), where the lower die cores 513 are spaced apart from each other, and the lower die core passage 5131 of each of the lower die cores 513 is not fluidly communicated with the positioning block passages 521 of the adjacent two of the positioning blocks 52. When the lower die core assembly 5 is in the closed state, the connecting passage 531 of each of the sealing members 53 is fluidly communicated with the lower die core passage 5131 of the corresponding one of the lower die cores 513 and the positioning block passage 521 of the corresponding one of the positioning blocks 52.

The upper mold seat 6 is made of steel, and includes an upper mounting portion 63 that is upwardly concaved along the central axis (L), a downward facing surface 61 that faces the lower mold seat 4 and an upper insulating layer 62 that is formed on the downward facing surface 61.

The upper die core assembly 7 is mounted in the upper mounting portion 63 of the upper mold seat 6, and includes an upper die core unit 71 that covers the mold cavity 512.

The upper die core unit 71 includes an upper die core passage 711 that is adapted for the cooled gas to flow therethrough, and is made of a second porous material, such as steel or copper, so as to allow the cooled gas to flow out of the upper die core unit 71. In this embodiment, the upper die core unit 71 is made by one of powder metallurgy and 3D printing.

The lower heating unit 8 includes a lower high-frequency heating member 81 that is mounted to the lower mounting portion 43 of the lower mold seat 4, and that induces eddy current in at least one of the lower die core unit 51 and the lower mold seat 4 to heat up the at least one of the lower die core unit 51 and the lower mold seat 4. The lower heating unit 8 further includes a lower shielding layer 82 that is mounted in the lower mounting portion 43 of the lower mold seat 4, and that is located within the electromagnetic induction range of the lower high-frequency heating member 81 for preventing induction of eddy current in the lower mold seat 4 or to lower the eddy current induced in the lower mold seat 4. In this embodiment, the lower shielding layer 82 is disposed between the lower high-frequency heating member 81 and the lower mold seat 4. The lower heating unit 8 further includes a lower magnetic conducting layer 83 that is in direct contact with the lower die core unit 51 and that is located within the electromagnetic induction range of the lower high-frequency heating member 81.

The upper heating unit 9 includes an upper high-frequency heating member 91 that is mounted to the upper mounting portion 63 of the upper mold seat 6, and that induces eddy current in at least one of the upper die core unit 71 and the upper mold seat 6 to heat up the at least one of the upper die core unit 71 and the upper mold seat 6. The upper heating unit 9 further includes an upper shielding layer 92 that is mounted in the upper mounting portion 63 of the upper mold seat 6, and that is located within the electromagnetic induction range of the upper high-frequency heating member 91 for preventing induction of eddy current in the upper mold seat 6 or to lower the eddy current induced in the upper mold seat 6. In this embodiment, the upper shielding layer 92 is disposed between the upper high-frequency heating member 91 and the upper mold seat 6. The upper heating unit 9 further includes an upper magnetic conducting layer 93 that is in direct contact with the upper die core unit 71 and that is located within the electromagnetic induction range of the upper high-frequency heating member 91.

Referring to FIGS. 2 and 3, when the upper mold seat 6 and the upper die core assembly 7 are connected to the lower mold seat 4 and the lower die core assembly 5 and when the lower die core assembly 5 is in the closed state, the connecting passage 531 of each of the sealing members 53 is fluidly communicated with the lower die core passage 5131 of the corresponding one of the lower die cores 513 and the positioning block passage 521 of the corresponding one of the positioning blocks 52, and the foaming material 3 in the mold cavity 512 is molded.

If electricity is supplied to the lower high-frequency heating member 81 and the upper high-frequency heating member 91, eddy current will be induced in the lower magnetic conducting layer 83 and the upper magnetic conducting layer 93 and the lower magnetic conducting layer 83 and the upper magnetic conducting layer 93 will be heated up. Since the lower die core unit 51 and the upper die core unit 71 are respectively in direct contact with the upper magnetic conducting layer 93 and the lower magnetic conducting layer 83, the lower die core unit 51 and the upper die core unit 71 will also be heated up due to thermal conduction. A heated gas is introduced into the upper die core passage 711 of the upper die core unit 71, the mold plate passage 5111 of the mold plate 511, the lower die core passages 5131 of the lower die cores 513 and the positioning block passages 521 of the positioning blocks 52, and flows out of the upper die core unit 71, the mold plate 511 and the lower die cores 513 due to the porosity of the same. Therefore, the foaming material 3 in the mold cavity 512 can be uniformly heated.

After heating and molding the foaming material 3, the cooled gas is introduced into the upper die core passage 711 of the upper die core unit 71, the mold plate passage 5111 of the mold plate 511, the lower die core passages 5131 of the lower die cores 513 and the positioning block passages 521 of the positioning blocks 52, and flows out of the upper die core unit 71, the mold plate 511 and the lower die cores 513 due to the porosity of the same. Therefore, the foaming material 3 in the mold cavity 512 can be uniformly cooled.

It is worth mentioning that the exits of the lower die core passages 5131, the mold plate passage 5111 and the upper die core passage 711 may be provided with valves (not shown) for controlling the amount of the heated or cooled gases entering the same.

It is worth mentioning that, although the lower mold seat 4 and the upper mold seat 6 are magnetically conductive, the lower shielding layer 82 and the upper shielding layer 92 can prevent eddy current to be inducted in the lower mold seat 4 and the upper mold seat 6 or to lower the eddy current induced in the lower mold seat 4 and the upper mold seat 6.

Moreover, the lower insulating layer 42 and the upper insulating layer 62 can prevent electric arc from occurring between and damaging the lower mold seat 4 and the upper mold seat 6 when the upward facing surface 41 and the downward facing surface 61 are driven toward each other.

Referring to FIGS. 6 and 7, when the upper mold seat 6 and the upper die core assembly 7 are away from the lower mold seat 4 and the lower die core assembly 5, and the lower die core assembly 5 is converted into the open state, the lower die cores 513 are spaced apart from each other, and the lower die core passage 5131 of each of the lower die cores 513 is not fluidly communicated with the positioning block passages 521 of the adjacent two of the positioning blocks 52, thereby allowing the molded foaming material 3 to be removed from the mold cavity 512 by an automated removing device (not shown).

In summary, the porous lower die core unit 51, the porous upper die core unit 71 and the abovementioned passages allow the heated or cooled gases to flow out, so as to increase heating or cooling speed and to uniformly heat or cool the foaming material 3 in the mold cavity 512. Moreover, after heating, the foaming material 3 can be subsequently cooled without moving to another mold, thereby decreasing process time and avoiding damage to the foaming material 3 while transferring.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A molding device adapted to cool down a molded foaming material, said molding device comprising:
a lower mold seat;
a lower die core assembly mounted to said lower mold seat, and including a lower die core unit that defines a mold cavity, said lower die core unit including an internal loop adapted for a cooled gas to flow therethrough, and being made of a first porous material so as to allow the cooled gas to flow out of said lower die core unit;
an upper mold seat; and
an upper die core assembly mounted to said upper mold seat, and including an upper die core unit that covers said mold cavity, said upper die core unit including an upper die core passage adapted for the cooled gas to flow therethrough, and being made of a second porous material so as to allow the cooled gas to flow out of said upper die core unit.

2. The molding device as claimed in claim 1, wherein each of said first and second porous materials is one of steel and copper.

3. The molding device as claimed in claim 1, wherein each of said lower and upper die core units is made by one of powder metallurgy and 3D printing.

4. The molding device as claimed in claim 1, wherein said lower die core unit includes a mold plate that is mounted to said lower mold seat, and at least two lower die cores, said lower die core assembly further including at least two positioning blocks that are disposed on said mold plate of said lower die core unit, said mold plate including a mold plate passage adapted for the cooled gas to flow therethrough, said lower die cores surrounding a central axis and being movably disposed on said mold plate, each of said lower die cores including a lower die core passage and being disposed between said positioning blocks, said lower die core assembly being convertible between a closed state, where said lower die core passage of each of said lower die cores is fluidly communicated with said positioning block passages of said positioning blocks, and an open state, where said lower die cores are spaced apart from each other, and said lower die core passage of each of said lower die cores is not fluidly communicated with said positioning block passages of said positioning blocks.

5. The molding device as claimed in claim 4, wherein:
said lower die core assembly further includes a plurality of sealing members, each of said sealing members including a connecting passage and being sealingly disposed between a corresponding one of said lover die cores and a corresponding one of said positioning blocks; and
when said lower die core assembly is in the closed state, said connecting passage of each of said sealing members is fluidly communicated with said lower die core passage of the corresponding one of said lower die cores and said positioning block passage of the corresponding one of said positioning block.
